(19) United States
(12) Patent Application Publication
(10) Pub. No.: US 2018/0102010 A1
(43) Pub. Date: Apr. 12, 2018

(54) ELECTRONIC CHILD LOCK CONTROL SYSTEM

(71) Applicant: FORD GLOBAL TECHNOLOGIES, LLC, Dearborn, MI (US)

(72) Inventors: Jose Antonio Segura Salgado, Puebla (MX); Ricardo David Luna Olvera, Mexico City (MX)

(21) Appl. No.: 15/287,786

(22) Filed: Oct. 7, 2016

(51) Int. Cl. G07C 9/00

(52) U.S. Cl. CPC G07C 9/00857; G07C 2009/00507; G07C 9/00309; G07C 9/00896

(57) ABSTRACT

A child-proof door lock control system for a vehicle includes a human-machine interface (HMI) and a computing device comprising a memory, storage, and one or more processors. The one or more processors include computer-executable instructions defining protected controls accessible via the HMI for operating one or more child-proof locks. The protected controls are accessible via the HMI on receipt of a user input. The one or more processors may further include computer-executable instructions for engaging the child proof locks at predetermined time periods. Methods for controlling a child-proof door lock system are provided.

### TECHNICAL FIELD

This disclosure relates generally to motor vehicle locking systems. More particularly, the disclosure relates to a child-proof lock system conveniently controlled via a vehicle human-machine interface (HMI).

### BACKGROUND

Modern motor vehicles include various child-oriented safety features such as child-proof lock mechanisms which, when engaged, ensure that a vehicle door such as the front and/or rear passenger doors cannot be deliberately or inadvertently unlocked and/or opened from an interior of the vehicle. Such child-proof lock mechanisms are conventionally engaged and disengaged by way of dedicated actuators such as buttons or switches. The dedicated actuators are often placed in an area of a vehicle door that is inaccessible when the door is closed, but it is also known to place the dedicated actuators within the vehicle driver's easy reach. It is common and indeed required in some jurisdictions to associate child-proof lock mechanisms at least with rear doors of a vehicle, although it is also known to include such mechanisms in association with a front passenger door.

Once engaged, the lock mechanisms render the interior door handles useless until the lock mechanisms have been disengaged. In some cases, the mechanism cannot be disengaged without opening a desired vehicle door from the exterior of the vehicle. Some other designs require use of a vehicle key to disengage the lock mechanism. This can be inconvenient for adult passengers seated in a rear seat of the vehicle, who must wait for the driver or another vehicle occupant to disengage the child-proof locking mechanism or exit the vehicle and open a vehicle door from the vehicle exterior before they can exit the vehicle. Moreover, buttons and switches can potentially be accessed by a child who can then disable the child-proof locking mechanisms, risking injury.

Accordingly, a need is identified in the art for improvements to child-proof locking mechanisms. To address this identified need, the present disclosure is directed to a child-proof locking system which is conveniently controlled via a vehicle human machine interface (HMI), and to methods of controlling same.

### SUMMARY

In accordance with the purposes and benefits described herein and to solve the above-summarized and other problems, in one aspect a child-proof door lock control system for a vehicle is provided, comprising a human-machine interface (HMI) and a computing device comprising a memory, storage, and one or more processors. The one or more processors comprise computer-executable instructions defining protected controls accessible via the HMI for operating one or more child-proof locks. As is known the child-proof locks, when engaged, prevent opening of one or more vehicle passenger doors from an interior of the vehicle.

The one or more processors further comprise computer-executable instructions configured to present, via the HMI, a user interface including in embodiments one or more of a menu, a menu drop-down, and icons providing access to the protected controls. The one or more processors further comprise computer-executable instructions configured to allow access to the protected controls on receipt of a user input, in embodiments selected from one or more of an alphanumeric password, an alphanumeric code, and a biometric input.

In embodiments, the one or more processors may further comprise computer-executable instructions configured to engage the child-proof locks at predetermined time periods. In embodiments, the HMI may be associated with an in-vehicle information/entertainment center.

In other aspects, methods for controlling a child-proof door lock using the control system described above are provided.

In the following description, there are shown and described embodiments of an HMI-controlled child-proof locking mechanism and of methods for controlling a child-proof locking mechanism. As it should be realized, the described devices and methods are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed HMI-controlled child-proof locking mechanism and methods for controlling same, and together with the description serve to explain certain principles thereof. In the drawing:

FIG. 1 depicts in block diagram form a child-proof locking mechanism control system according to the present disclosure;

FIG. 2 depicts in flow chart form a method for controlling a child-proof locking mechanism according to the present disclosure;

FIG. 3 depicts in flow chart form an alternative embodiment of a method for controlling a child proof locking mechanism according to the present disclosure;

FIG. 4A depicts an embodiment of an input screen for a vehicle human-machine interface (HMI) for use with the described child-proof locking mechanism control system;

FIG. 4B depicts an alternative embodiment of the input screen of FIG. 4A;

FIG. 4C depicts another alternative embodiment of the input screen of FIG. 4A; and

FIG. 5 depicts a vehicle including a child-proof locking mechanism control system according to the present disclosure, associated with an in-vehicle entertainment/information center.

Reference will now be made in detail to embodiments of the disclosed HMI-controlled child-proof locking mechanism and methods for controlling same, examples of which are illustrated in the accompanying drawing figures wherein like reference numerals indicate like features.

### DETAILED DESCRIPTION

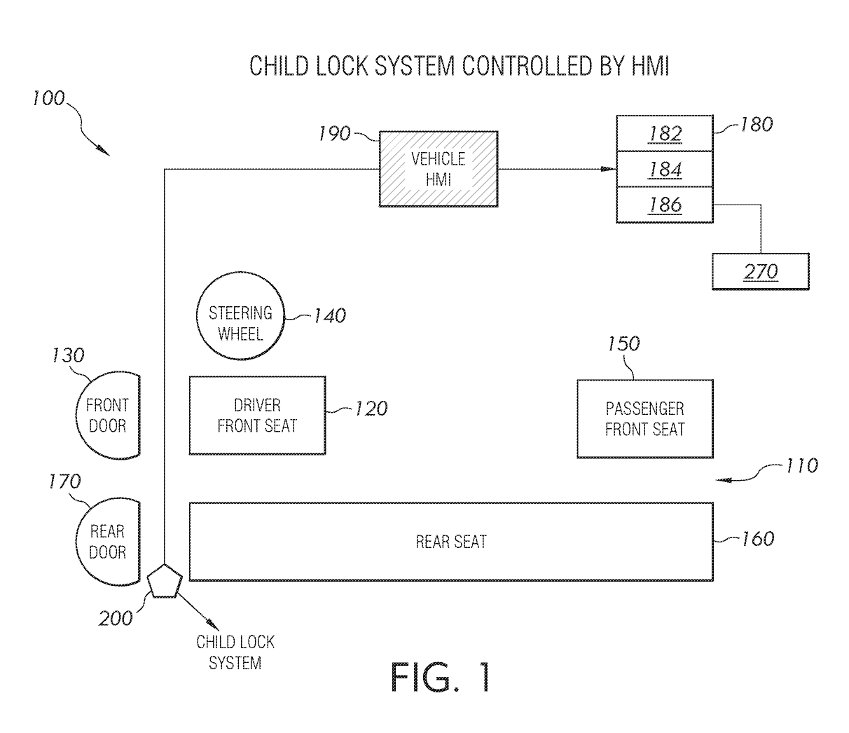

With reference to FIG. 1, there is represented a child-proof locking mechanism control system 100 for a vehicle 110 including a drivers' seat 120 disposed adjacent to a driver-side front door 130 and a steering wheel 140, a front passenger seat 150 disposed adjacent to a passenger-side front door (not shown), and one or more rear passenger seats 160 adjacent to rear doors 170 (only one rear door 170 shown). The child-proof locking mechanism control system 100 includes a computing device 180 in operative communication with a vehicle human-machine interface (HMI) 190 and a child lock system 200. As is known and as summarized above, the child lock system 200 comprises electronic locking mechanisms associated at least with the rear doors 170 (and potentially with the passengers-side front door) which, when engaged, prevent unlocking and/or opening the vehicle door with which the mechanisms are associated from an interior of the vehicle 110.

As will be appreciated, the computing device 180 may be a computing device or controller already known to be associated with a vehicle to control various electrical systems and subsystems, for example as the Body Control Module (BCM). Alternatively, the computing device 180 may be a separate computing device or controller dedicated only to monitoring/controlling the presently described child-proof locking mechanism control system.

The nature and design of computing devices/controllers such as are used to control and monitor various vehicle 110 system functions are well-known in the art. At a high level, such computing devices 180 comprise processors or microprocessors 182, storage 184, and memory 186. The computing devices 180 may communicate with the systems they control or with other vehicle controllers via a serial bus (e.g., Controller Area Network (CAN)) or via dedicated electrical conduits. The computing device 180 generally includes any number of processors/microprocessors 182, ASICs, ICs, memory 184 (e.g., FLASH, ROM, RAM, EPROM and/or EEPROM) and software code comprising computer executable instructions to co-act with one another to perform a series of operations. The computing device 180 may communicate with other vehicle systems and computing devices over one or more wired or wireless vehicle connections using common bus protocols (e.g., CAN and LIN). Used herein, a reference to “a controller” or “a computing device” refers to one or more controllers or computing devices.

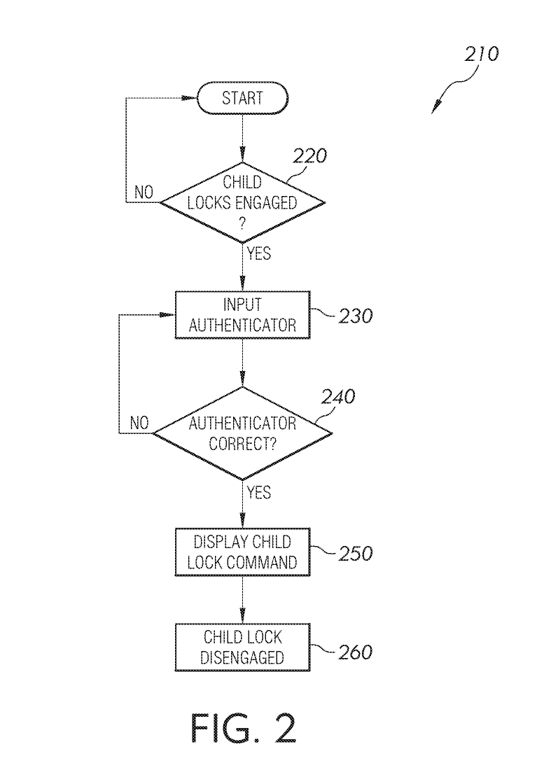

FIG. 2 shows an exemplary method 210 for controlling a child lock system 200. At step 220, the computing device 180 queries the system and determines that the child lock system is engaged. A user such as the vehicle 110 driver who desires to disengage the child lock system 200, can request access to the child lock system commands by way of the HMI 190. As is known, the HMI 190 may allow access to the menu by a variety of systems. For example, the vehicle 110 may include an actuator for a pointer which points to/highlights desired icons, drop-downs, etc. Alternatively, the HMI 190 may include a touch screen allowing the user to use her own finger to highlight and access the icons, drop-downs, etc.

The user is then required to input an authenticator, for example a password, access code, etc. by way of the HMI 190 (step 230). The computing device 180 determines whether the input authenticator is correct, i.e. matches a saved record corresponding to the input authenticator (step 240). If so, the computing device 180 issues instructions to display a set of commands or controls on an HMI 190 display screen (step 250) associated with the child lock system 200, which commands or controls may include a command to disengage the child lock system 200 (step 260). The HMI 190 display screen may further display a notification of the status of the child lock system 200, i.e., whether the child-proof locks associated with the child lock system 200 are engaged or disengaged.

Of course, use of alternative authenticators is possible and contemplated. For example, it is known to utilize biometric inputs as authenticators, for example fingerprints, retinal scans, etc. to allow access to computing systems. As another alternative, an identification card may be provided which may be scanned or swiped to provide access to the commands or controls associated with the child lock system 200. All such user input authenticators are contemplated for use herein.

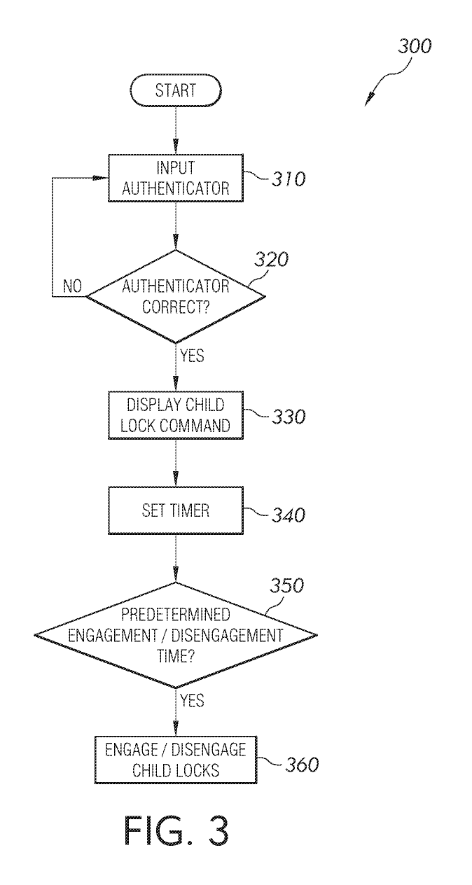

In an alternative embodiment (see FIG. 3), a method 300 of the present disclosure may include steps of setting one or more predetermined time periods within which the child lock system 200 will automatically engage by default without further user input. For example, a vehicle 110 owner may know that most commonly he will be transporting children between the hours of 9 am and 5 pm each day, 9 am-5 pm on weekdays only, etc. In this embodiment, the computing device 180 is in operative communication with a timer 270 (see FIG. 1), which may be comprised in a processor 182 associated with the computing device, or may be separate from the computing device.

As shown in the drawing, a user at step 310 inputs an authenticator which at step 320 is verified as described above. If verified, the computing device 180 issues instructions to display the set of commands or controls on an HMI 190 display screen (step 330) associated with the child lock system 200, which commands or controls may include a command to set a timer controlling automatic engagement/disengagement of the child lock system 200 (step 340).

The computing device 180 may issue a query at intervals to determine if the predetermined time for engaging/disengaging the child lock system 200 has arrived (step 350). If not, the computing device takes no action. If so, the computing device 180 issues instructions to a child lock system controller associated with the child lock system 200 to engage/disengage the system as appropriate. As will be appreciated, the child lock system controller may be associated with a processor 182 of the computing device 180m, or may be a stand-alone controller.

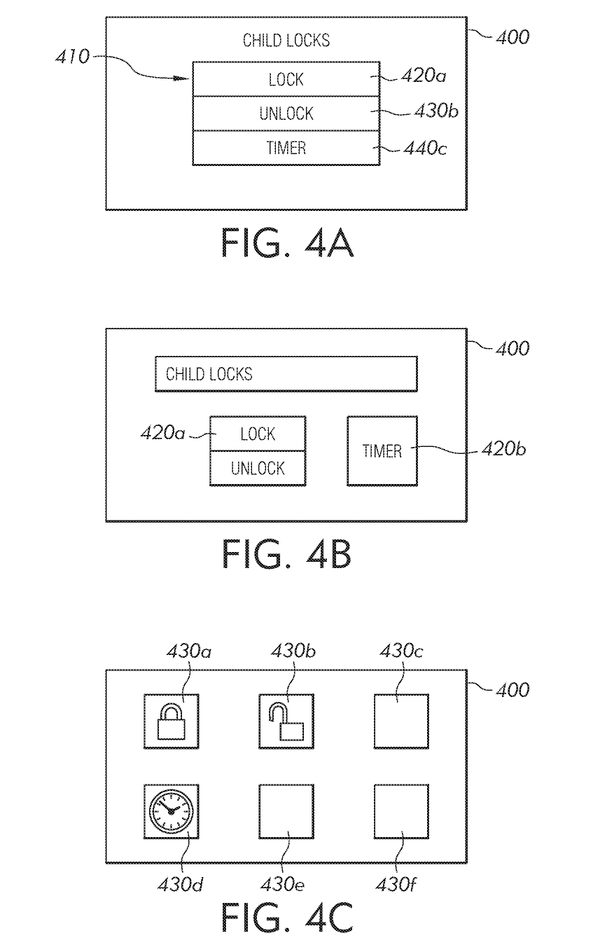

As will be appreciated, the set of commands or controls associated with the child lock system 200 which are displayed on the HMI 190 display screen 400 may be represented in a variety of ways. For example, as shown in FIG. 4A, a menu 410 may be displayed including a plurality of selectable commands 410a . . . n. Alternatively, as shown in FIG. 4B a taskbar 420 may be displayed including a plurality of drop-downs 420a . . . n, including selectable commands, input areas such as for setting the timer 270, etc. Still further, as shown in FIG. 4C the display screen 400 may display a plurality of icons 430a . . . n each representing a particular command associated with the child lock system 200. All such input methods, and combinations thereof, are contemplated for use herein. As described above, the various selectable commands 410, drop-downs 420, and/or icons 430 may be operated by way of a vehicle-associated pointer, by a touchscreen display 400, etc.

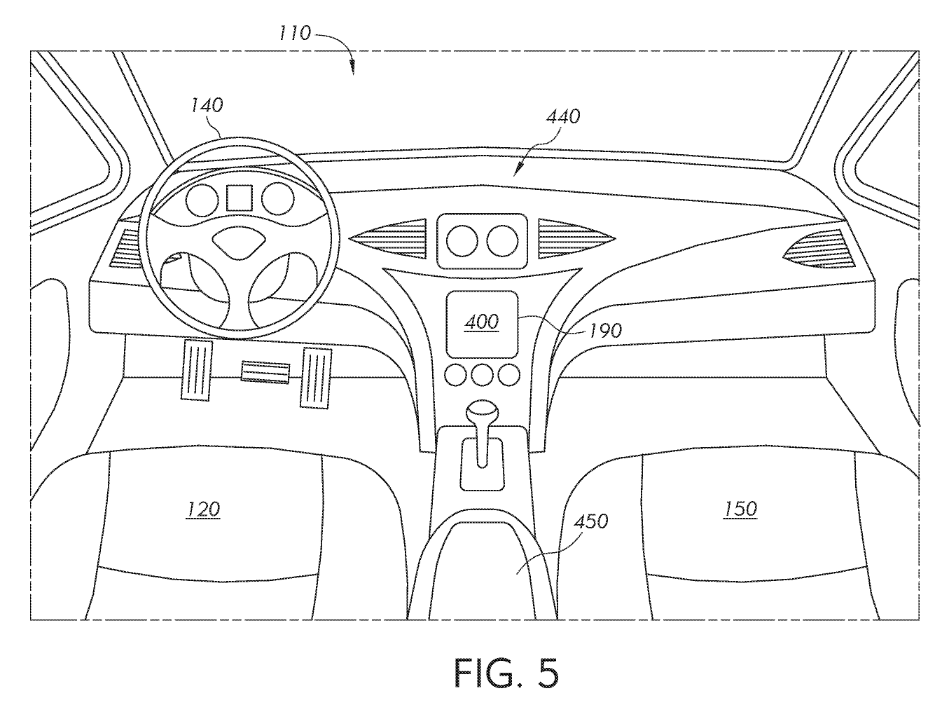

FIG. 5 depicts a vehicle 110 including the child lock system 200 (not visible in this view) and child locking mechanism control system 100 described above. As depicted, the HMI 190 and associated display screen 400 are associated with a dash panel 440 of the vehicle. However, it is also known to associate vehicle HMIs 190 with other elements of a vehicle interior, for example a center console 450, a headliner-mounted console (not shown), a steering wheel 140, and others. All such alternative placements are contemplated for use herein. As will be appreciated, by use of the described system 100 a vehicle 110 driver can conveniently disengage the child lock system 200 to, e.g., allow adult passengers to exit the vehicle without assistance without compromising safety by providing controls accessible to children.

The foregoing has been presented for purposes of illustration and description. It is not intended to be exhaustive or to limit the embodiments to the precise form disclosed. Obvious modifications and variations are possible in light of the above teachings. For example, a display may be provided to the user indicating a status of the child lock system 200, i.e. engaged or disengaged. In turn, it is contemplated to provide for automatic disengagement of the child lock system 200 in the event of an emergency such as a collision, for example by operatively connecting the computing device 180 to one or more collision sensors. Automatic disengagement of the child lock system 200 in case of other emergencies is contemplated, for example an electronic failure, and others. All such modifications and variations are within the scope of the appended claims when interpreted in accordance with the breadth to which they are fairly, legally and equitably entitled.

1. A child-proof door lock control system for a vehicle, comprising:
an onboard human-machine interface (HMI); and
an onboard computing device comprising a memory, storage, and one or more processors;
the one or more processors comprising computer-executable instructions defining protected controls accessible via the HMI for operating one or more child-proof locks.

2. The child-proof door lock control system of claim 1, wherein the one or more child-proof locks, when engaged, prevent opening of one or more vehicle passenger doors from an interior of the vehicle.

3. The child-proof door lock control system of claim 1, wherein the one or more processors further comprise computer-executable instructions configured to present, via the HMI, a user interface including one or more of a menu, a menu drop-down, and icons providing access to the protected controls.

4. The child-proof door lock control system of claim 1, wherein the one or more processors further comprise computer-executable instructions configured to allow access to the protected controls on receipt of a user input selected from one or more of an alphanumeric password, an alphanumeric code, and a biometric input.

5. The child-proof door lock control system of claim 1, wherein the one or more processors further comprise computer-executable instructions configured to engage the child-proof locks at predetermined time periods.

6. The child-proof door lock control system of claim 1, wherein the HMI is associated with an in-vehicle information/entertainment center.

7. A vehicle including the child-proof door lock control system of claim 1.

8. A child-proof door lock control system for a vehicle, comprising:
an onboard human-machine interface (HMI); and
an onboard computing device comprising a memory, storage, and one or more processors;
the one or more processors comprising computer-executable instructions defining protected controls accessible via the HMI for operating one or more child-proof locks;
the one or more processors further comprising computer-executable instructions configured to engage the child-proof locks at predetermined time periods.

9. The child-proof door lock control system of claim 8, wherein the child-proof locks, when engaged, prevent opening of one or more vehicle passenger doors from an interior of the vehicle.

10. The child-proof door lock control system of claim 8, wherein the one or more processors further comprise computer-executable instructions configured to present, via the HMI, a user interface including one or more of a menu, a menu drop-down, and icons providing access to the protected controls.

11. The child-proof door lock control system of claim 8, wherein the one or more processors further comprise computer-executable instructions configured to allow access to the protected controls on receipt of a user input selected from one or more of an alphanumeric password, an alphanumeric code, and a biometric input.

12. The child-proof door lock control system of claim 8, wherein the HMI is associated with an in-vehicle information/entertainment center.

13. A vehicle including the child-proof door lock control system of claim 8.

14. A method for controlling a child-proof door lock system of a vehicle, comprising providing an onboard computing device comprising a memory, storage, and one or more processors comprising computer-executable instructions defining protected controls accessible via an onboard human-machine interface (HMI) for operating one or more child-proof locks.

15. The method of claim 14, including configuring the child-proof locks to, when engaged, prevent opening of one or more vehicle passenger doors using an interior control associated with the one or more vehicle passenger doors.

16. The method of claim 14, including providing the one or more processors further comprising computer-executable instructions configured to present, via the HMI, a user interface including one or more of a menu, a menu drop-down, and icons providing access to the protected controls.

17. The method of claim 14, including providing the one or more processors further comprising computer-executable instructions configured to allow access to the protected controls on receipt of a user input selected from one or more of an alphanumeric password, an alphanumeric code, and a biometric input.

18. The method of claim 14, including providing the one or more processors further comprising computer-executable instructions configured to engage the child-proof locks at predetermined time periods.

19. The method of claim 14, including associating the HMI with an in-vehicle information/entertainment center.
